(19) United States
(12) Patent Application Publication
(10) Pub. No.: US 2013/0339126 A1
(43) Pub. Date: Dec. 19, 2013

(54) CAMPAIGN PERFORMANCE FORECASTING FOR NON-GUARANTEED DELIVERY ADVERTISING

(71) Applicants: Ying Grace Cui, Sunnyvale, CA (US); Ruofei Zhang, Mountain View, CA (US)

(72) Inventors: Ying Grace Cui, Sunnyvale, CA (US); Ruofei Zhang, Mountain View, CA (US)

(73) Assignee: YAHOO! INC., Sunnyvale, CA (US)

(21) Appl. No.: 13/495,614

(22) Filed: Jun. 13, 2012

(51) Int. Cl. G06Q 30/02

(52) U.S. Cl. 705/14.41

(57) ABSTRACT

Advertisement (“ad”) campaign forecasting may predict results for the campaign and the ads included in the campaign. The results may include a forecast for impressions, clicks, conversions, and/or interactions with the ads. The forecasting may be utilized for display advertising with non-guaranteed delivery (“NGD”) systems in which a bidding platform allows advertisers to bid for ad impressions, clicks, and/or conversions. Forecasting results may be used by advertisers to manage and optimize campaigns.

### BACKGROUND

Online advertising may be an important source of revenue for enterprises engaged in electronic commerce. Processes associated with technologies such as Hypertext Markup Language (“HTML”) and Hypertext Transfer Protocol (“HTTP”) enable a web page to be configured to display advertisements. Advertisements may commonly be found on many web sites. Web site publishers, such as news and sports web sites, may provide space for advertisements. The publishers of these web sites may sell advertising space to advertisers to defray the costs associated with operating the web sites as well as to obtain additional revenue.

Non-guaranteed display advertising (“NGD”) may refer to advertising in which advertisers pay based on ad performance and results. Advertisers in NGD may sell a large portion of their ad campaigns using performance dependent pricing models such as cost-per-click (“CPC”) and cost-per-action (“CPA”). Pricing for NGD advertising may be difficult because it may be necessary to forecast or predict the success for particular ads or ad campaigns.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a diagram of an exemplary network system;

FIG. 2 is a diagram of a forecasting system; and

FIG. 3 is a flow chart of forecasting data flow.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

By way of introduction, advertisement (“ad”) campaign forecasting may predict results for that campaign and the ads included in the campaign. The results may include a forecast for impressions, clicks, conversions, and/or interactions with the ads. The forecasting may be utilized for display advertising with non-guaranteed delivery (“NGD”) systems in which a bidding platform allows advertisers to bid for ad impressions, clicks, and/or conversions. Forecasting results may be used by advertisers to manage and optimize campaigns. In particular, budgeting and inventory availability may be assisted with forecasting.

Advertisers may be provided with a wide range of pricing models. Similar to guaranteed delivery (“GD”) advertisements, advertisers with NGD ads can choose to pay per impression (“CPM”). However, advertisers may also prefer to pay if the ad attracted the user's attention. Accordingly, an additional type of NGD advertising payment scheme provides performance based pricing models such as pay-per click (“CPC”) and pay-per-conversion (“CPA”), which can be further categorized as post-view or post-click, depending on there being a click before the conversion event. In a marketplace where ads with different payment models are competing for the same opportunity, the auction mechanism may need to convert the bids to a common currency. This may be accomplished by computing expected revenue (“eCPM”). For a CPM ad, the expected revenue is going to be the same as the bid. For a CPC ad, however, the expected revenue depends on the probability that the user will click on that ad. Similarly, the expected revenue of a post-view CPA ad depends on the probability of conversion after the user views the ad; and for post-click CPA the expected revenue calculation may take into account both the click and the conversion probability. As a result, accurate forecasting (e.g. prediction of click probability) may be important in NGD advertising.

In NGD advertising a spot auction may be run for every ad slot on the publisher's page, in which advertisers with matching target profiles participate. The ads may be ranked based on their expected revenue and the winning ad is displayed. Estimating the expected revenue for pay-per click and post-click conversion payment models requires knowing the probability that the user will click on the candidate ad if shown in that ad slot on the publisher's page. An NGD system may rely on machine learning models to forecast the click probability of eligible CPC/CPA ads. These models may be trained using data collected from live systems. The identity of the users, publishers and ads may be used as features in such models, together with other high level category information. For ads that have been in the system for a long period of time, the forecasting of click probability using identifier based features may be generally reliable, however it becomes more difficult for new ads and new campaigns.

The NGD forecasting system may forecast the number of won impressions, clicks, and/or conversions for a given advertising campaign's parameters (including campaign pricing and goal type, bid and goal amount, targeting attributes etc.). Accordingly, any entity that is buying (e.g., advertiser and ad network) or selling media (e.g., publisher and pub network) in the NGD marketplace to may have better intelligence for their optimization. Improved forecasting accuracy may provide guidance as to what can be delivered should the campaign bid or a goal price be increased or decreased or the targeting attributes be changed. The NGD forecasting system we developed simulates the end to end NGD exchange system to replay the real-time bidding scenario.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below.

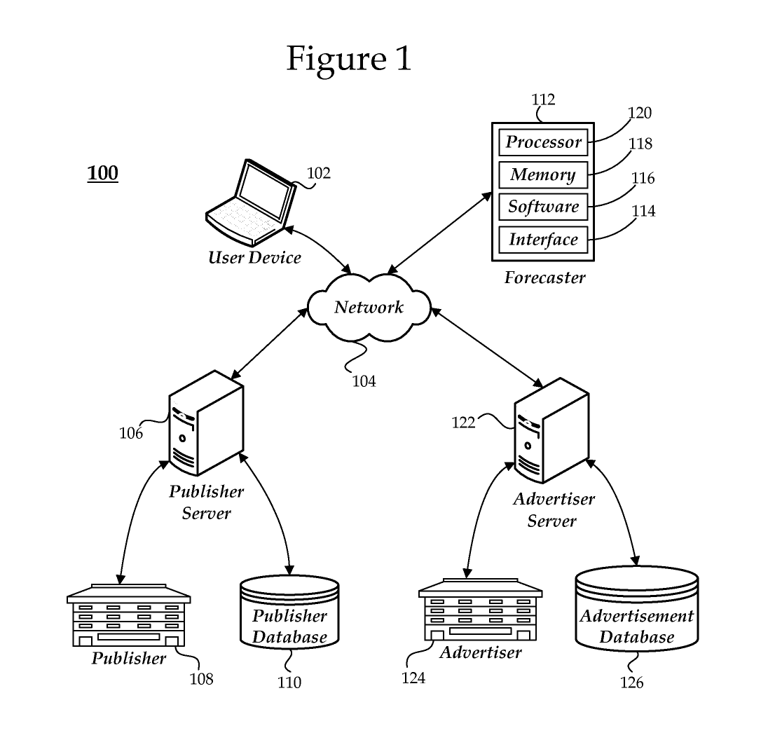

FIG. 1 depicts a block diagram illustrating one embodiment of an exemplary advertising system 100. The advertising system 100 may provide a platform for implementing and displaying NGD advertisements. In the advertising system 100, a user device 102 is coupled with a publisher server 106 through a network 104. The publisher server 106 may be operated by and/or coupled with a publisher 108, as well as being coupled with a publisher database 110. An advertiser server 122 coupled with an advertiser 124 may also be coupled with an advertisement database 126. A forecaster 112 may be coupled with the publisher server 106 and the advertiser server 122. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided. Accordingly, the forecaster 112 may be coupled through a network (e.g. the network 104) with the publisher server 106 and the advertiser server 122.

The user device 102 may be a computing device which allows a user to connect to a network 104, such as the Internet. As described below, the user device 102 may be a third party user who views an advertisement. In alternative embodiments, the user device 102 as described herein may be how the publisher and/or advertiser 124 accesses the NGD advertisement system for buying, selling, and click-predicting of advertisements. The user device 102 may also be referred to as a client device.

The user device 102 may include a computing device capable of sending or receiving signals, such as via a wired or a wireless network (e.g. the network 104, which may be the Internet). The user device 102 may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. The user device 102 may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

The user device 102 may include or may execute a variety of operating systems, including a personal computer operating system, such as a Windows, iOS or Linux, or a mobile operating system, such as iOS, Android, or Windows Mobile, or the like. The user device 102 may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. The user device 102 may also include or execute an application to communicate content, such as, for example, textual content, multimedia content, or the like. The user device 102 may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

In one embodiment, the user device 102 is configured to request and receive information from a network (e.g. the network 104, which may be the Internet). The information may include web pages with advertisements. The user device 102 may be configured to access other data/information in addition to web pages over the network 104 using a web browser, such as INTERNET EXPLORER (sold by Microsoft Corp., Redmond, Wash.) or FIREFOX® (provided by Mozilla). In an alternative embodiment, software programs other than web browsers may also display advertisements received over the network 104 or from a different source. As described below, the ads are displayed in a web page and the forecasting system is used for the sale of publisher ad space for those ads.

In one embodiment, the publisher server 106 provides an interface to a network 104 and/or provides its web pages over the network, such as to the user device 102. The publisher server 106 may be a web server that provides the user device 102 with pages (including advertisements) that are requested over the network, such as by a user of the user device 102. In particular, the publisher 108 may provide a web page, or a series of web pages that are provided by the publisher server 106 when requested from the user device 102. For example, the publisher may be a news organization, such as CNN® that provides all the pages and sites associated with www.cnn.com. Accordingly, when the user device 102 requests a page from www.cnn.com, that page is provide over the network 104 by the publisher server 106. That page may include advertising space or advertisement slots that are filled with advertisements viewed with the page. The publisher server 106 may be operated by a publisher 108 that maintains and oversees the operation of the publisher server 106.

The publisher 108 may be any operator of a page displaying advertisements that receives a payment from the advertisers of those advertisements. As described, the forecasting results may be used below by the publisher 108 for pricing the sale of the ad slots in the publisher's pages. The publisher 108 may oversee the publisher server 106 by receiving advertisements from an advertiser server 122 that are displayed in pages (e.g. a destination web page) provided by the publisher server 106. In one embodiment, a forecaster 112 may be used by the publisher 108 to accurately price the sale of ad slots/locations on one or more of its pages.

The publisher database 110 may be coupled with the publisher server 106 and may store the publisher's pages or data that is provided by the publisher server 106. The pages that are stored may have ad slots for displaying advertisements. The publisher database 110 may include records or logs of at least a subset of the requests for data/pages and ads submitted to the publisher server 106. In one example, the publisher database 110 may include a history of Internet browsing data related to the pages provided by the publisher server 106. The publisher database 110 may store advertisements from a number of advertisers, such as the advertiser 124. In addition, the publisher database 110 may store records on the advertisements that are shown and the resulting impressions, clicks, and/or actions taken for those advertisements. The data related to advertisement impressions, clicks and resulting actions may be stored in either the publisher database 110 and/or an advertiser database 126. This data can be used for the pricing of future NGD ads and ad campaigns

The advertiser server 122 may provide advertisements for display in web pages, such as the publisher's pages. In one embodiment, the advertiser server 122 is coupled with the publisher server 106 for providing ads on the publisher's web pages. The advertiser 124 may be any operator of the advertiser server 122 for providing advertisements. The advertisements may relate to products and/or services provided by the advertiser 124. The advertiser 124 may pay the publisher 108 for advertising space on the publisher's page or pages. The payment may be based on the forecasting results or click prediction described below for NGD ads. The advertiser 124 may oversee the advertiser server 122 by providing advertisements to the publisher server 106. The advertiser 124 may pay the publisher 108 for each impression, click, and/or conversion from the ads displayed on the publisher's pages.

The publisher server 106 and/or the advertiser server 122 may be one or more computing devices which may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

In addition, the publisher server 106 and/or the advertiser server 122 may be or may be part of a content server. A content server may include a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc. A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, etc.

The forecaster 112 may estimate a success for an ad or an ad campaign by predicting whether a user will view (impressions), click, or interact with (conversions) an advertisement as further described with respect to FIG. 3. The succession may include prediction of impressions, clicks, and/or conversions. In one embodiment, the forecasting may be designed for new ads or new ad campaigns for which there are no historical click/interaction information. As described, forecasting may include a prediction on whether a user will click on an ad and/or whether a user will interact with an ad and/or whether a conversion may result from the interaction with the ad. The click prediction may incorporate historical click data for related or similar advertisements.

The forecaster 112 may predict impressions/clicks/interactions/conversions for ads (e.g. new ads with no historical data) as discussed below. The forecaster 112 may be coupled with the publisher server 106 and the advertiser server 122 for providing the predictions which may be used in the sale of the ads for display. In one embodiment, the ad may be provided by the advertiser server 122 for forecasting analysis to estimate a future success of the ad. The forecasts may be used to establish the pricing for the display of that advertisement by the publisher server 106. In one embodiment, the forecaster 112 may be controlled by the publisher 108 and may be a part of the publisher server 106. Alternatively, the forecaster 112 may be controlled by the advertiser 124 and may be a part of the advertiser server 122, or may be part of a separate entity. The forecaster 112 may receive advertisements from a number of different advertisers, such as the advertiser 124. The forecaster 112 may be utilized by the different advertisers for testing different publishers' pages for displaying their ads. Likewise, the forecaster 112 may be utilized by the different publishers for identifying advertisers' ads that have the highest forecasted impression, click, or conversion rate.

The forecaster 112 may be a computing device for forecasting impressions, clicks, or conversions for ads or ad campaigns. The forecaster 112 may include a processor 120, memory 118, software 116 and an interface 114. The forecaster 112 may be a separate component from the publisher server 106 and/or the advertiser server 122, or may be combined as a single component or device.

The interface 114 may communicate with any of the user device 102, the publisher server 106, and/or the advertiser server 122. The interface 114 may include a user interface configured to allow a user and/or administrator to interact with any of the components of the forecaster 112. For example, the administrator and/or user may be able to configure and/or update the subsystems used by the forecaster 112 (e.g. the subsystems may include the blocks shown in FIG. 3).

The processor 120 in the forecaster 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program, such as code generated manually (i.e., programmed).

The processor 120 may be coupled with a memory 118, or the memory 118 may be a separate component. The interface 114 and/or the software 116 may be stored in the memory 118. The memory 118 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded ad or user data. Examples include a hard drive, compact disc (“CD”), digital video disc (“DVD”), memory card, memory stick, floppy disc, universal serial bus (“USB”) memory device, or any other device operative to store ad or user data. The memory 118 is operable to store instructions executable by the processor 120.

The functions, acts or tasks illustrated in the figures or described herein may be performed by the programmed processor executing the instructions stored in the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116. The software 116 may include instructions for forecasting of an ad or an ad campaign.

The interface 114 may be a user input device or a display. The interface 114 may include a keyboard, keypad or a cursor control device, such as a mouse, or a joystick, touch screen display, remote control or any other device operative to interact with the forecaster 112. The interface 114 may include a display coupled with the processor 120 and configured to display an output from the processor 120. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for providing input parameters. In particular, the interface 114 may allow a user to interact with the forecaster 112 to view or modify the forecasting system.

The present disclosure contemplates a computer-readable medium that includes instructions or receives and executes instructions responsive to a propagated signal, so that a device connected to a network can communicate voice, video, audio, images or any other data over a network. The interface 114 may be used to provide the instructions over the network via a communication port. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly. Any of the components in the advertising system 100 may be coupled with one another through a network, including but not limited to the network 104. For example, the forecaster 112 may be coupled with the publisher server 106 and/or the advertiser server 122 through a network. As another example, the advertiser database 126 may be coupled with the publisher server 106 and/or the forecaster 112 through a network. Accordingly, any of the components in the advertising system 100 may include communication ports configured to connect with a network, such as the network 104.

The network (e.g. the network 104) may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example. For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

The network connecting the devices described above (e.g. the network 104) may be a “content delivery network” or a “content distribution network” (CDN). For example, the publisher server 106 and/or the advertiser server 122 may be part of a CDN. A CDN generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Likewise, the network connecting the devices described above (e.g. the network 104) may be a peer-to-peer (or P2P) network that may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.” For example, the ad server 122 or the publisher server 106 may provide advertisements and/or content to the user device 102 over a P2P network, such as the network 104.

The publisher server 106, the publisher database 110, the forecaster 112, the advertiser server 122, the advertiser database 126, and/or the user device 102 may represent computing devices of various kinds. Such computing devices may generally include any device that is configured to perform computation and that is capable of sending and receiving data communications by way of one or more wired and/or wireless communication interfaces, such as interface 114. For example, the user device 102 may be configured to execute a browser application that employs HTTP to request information, such as a web page, from the publisher server 106. The present disclosure contemplates the use of a computer-readable medium that includes instructions or receives and executes instructions responsive to a propagated signal, so that any device connected to a network can communicate voice, video, audio, images or any other data over a network.

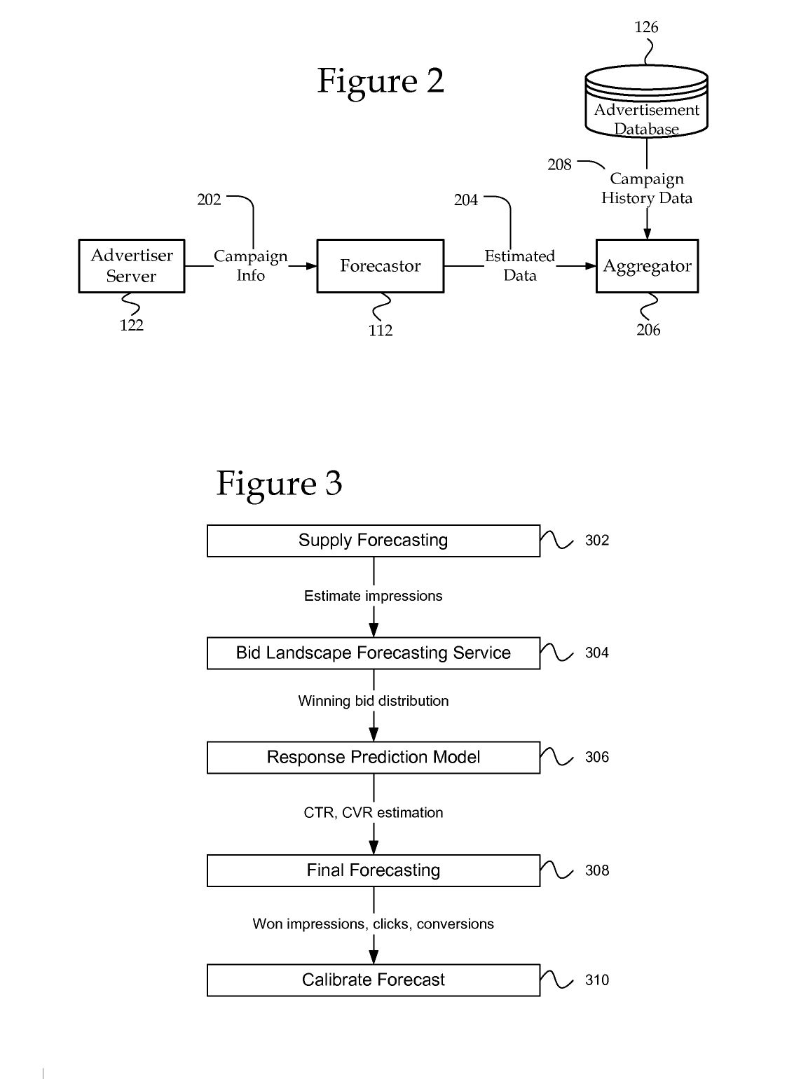

FIG. 2 is a diagram of a forecasting system. FIG. 2 illustrates inputs and outputs from the forecaster 112. In particular, campaign information 202 may be an input from the advertiser server 122. The campaign info 202 may be passed to the forecaster 112 through a component other than the advertiser server 122. The campaign info 202 may be a request for an ad campaign and may include campaign properties, such as a targeting profile, targeting attributes, campaign pricing, goal types, goal bids, and/or goal amounts. A targeting profile may include different advertisers' intended targeting attributes, such as publisher targeting (publisher, site, network, channel, etc.), user targeting (demographics, age, gender, geography, segments, etc.), day-parting targeting and others.

The forecaster 112 outputs estimated data 204. The estimated data 204 may include a predicted number of impressions, clicks, and/or conversions. The forecast or estimation by the forecaster 112 may be performed according to FIG. 3 as discussed below. In an alternative embodiment, the estimated data 204 may be input into an aggregator for comparing with campaign history data 208 from the advertisement database 126. In particular, the aggregator 206 may compare and refine the predictions (estimated data 204) by comparing with actual historical data (e.g. a click history of a similar ad). The aggregator 206 may improve upon the estimated data 204 by utilizing real/observed data (campaign history data 208). In another embodiment, the aggregator 206 may combine the results from a number of different samples with or without the campaign history data 208.

FIG. 3 is a flow chart of forecasting data flow. In particular, the blocks in FIG. 3 may represent different subsystems that are part of the forecasting system or the forecaster 112. In alternative embodiments, there may be more, fewer, or different subsystems as part of the forecasting. In block 302, a supply forecasting (“SF”) subsystem is applied for predicting impressions an ad campaign during a particular time interval or flight window. Each input campaign (e.g. from a line item file) may be matched to its targeting profile stored in the advertisement database 126 (which may be generated daily from the production database instance and dumped on Grid) for a certain time period. Each targeting profile may be composed of a set of complex boolean logics. For example, it may target for users with age 15-20 in the CA area, while excluding publisher Yahoo! Mail. It may also target at users interested in automobiles, and does not care about geography. After performing some mapping and conversion these targeting logics may be transformed to a query format for the supply forecasting engine to retrieve matched impressions. Then the query format of targeting rules may be sent to an engine/generator for sample generation.

In the system, any number of samples satisfying all the targeting rules for a certain campaign may be returned with their available impressions. For instance, if targeting rules are users with age 15-20 in the CA area visiting Yahoo! Sports, then two representative samples in the returned result would be age=15, geography=Calif., publisher=Yahoo! Sports and age=18, geography=Calif., publisher=Yahoo! Sports. The supply forecasting returns a required number of samples, and those samples are uniformly sampled from all the matched impressions, for example in a Fast-Bit index. Together with each sample, the eligible number of impressions (called weight) in the specified flight window may also be returned. The final outputs may be referred to as “available impressions” for the NGD campaign after deducting those impressions which may have already been booked. After some mapping and reformatting the representative samples for a NGD campaign may be outputted with predicted available impressions. The following sub-systems or blocks in FIG. 3 process these results as “supply.”

In one embodiment, the forecaster 112 receives campaign info 202, which is used to return a number of samples and the number of impressions for each sample as part of the SF 302. Each sample may be a representative impression of the matched impressions: The samples may be sent to the bid landscape forecasting service 304 (“BLS”) to estimate the winning bid distribution for each sample. BLS 304 is for winning bid distribution estimation and may estimate the win rate. The winning bid distribution may be used to predict a win rate of the campaign based on its calculated eCPM. The estimated win rate may be used to calculate the won impressions the NGD system actually delivered. The won impressions may equal the product of the available impressions times the win rate times the participation rate.

The role of BLS 304 may include predicting the winning bid distribution for a given supply sample. For example, the winning bid distribution may be predicted for a sample user age=18-22, geography=Calif., publisher=Yahoo! Sports, Segments=game lover or baseball fan, time=1-2 pm in Jan. 2, 2012. The BLS may also provide a′ won impression distribution with respect to the bid amount for advertising campaigns to predict the number of impressions a campaign can win if bidding at a certain bid amount. In this sub-system, the winning bid distribution of each sample may be modeled as log-normal distribution. BLS may be formalized as a regression problem to predict the parameters of winning bid distribution (i.e., mean and standard deviation) for each sample. To generate won impression distribution with respect to the bid (eCPM) for each campaign there may be a mixture of a log-normal model based on the sample-level forecasting results.

For an online bid history lookup, a bid parameter (mean and std) history lookup table may be generated for possible combinations of targeting attribute values at configurable aggregation level. This task may be achieved by introducing a bid star tree to expand observed samples to cover as much targeting space as possible and by retrieving the bid history for testing samples by searching in the tree with the help of templates to address coverage issues caused by data sparsity. Bid history lookup table may be organized into a tree structure, where each level corresponds to one targeting attribute and each path represents a sample. The attributes with few or no histories may be rolled up into it. For real time history lookup, templates may be introduced for the purpose of finding the most similar path in the tree when there is no exact match. The look-ups using multiple templates may be executed in parallel and the match with the most relevant template may be used. The retrieved history may serve as features in prediction of winning bid distribution parameters.

For bid distribution prediction, historical bid features may be utilized along with other user features and publisher features extracted from samples. A regression method for winning bid mean and standard deviation (“std”) forecasting may be used for those features. Least square gradient boosting tree may perform a least-squares residual fitting with a square-error loss function for the prediction. Feature importance may be a byproduct of the boosting trees model because it performs greedy feature search when selecting splitting features.

A user segment may be designed to identify a group of users which are of interest to advertisers or publishers. A user segment may include a number of targeting attributes for which an advertiser wants to target. Advertisers may define their own segments at any time, such as site re-targeting and search re-targeting segments. Each user may have hundreds segments assigned. Each advertising campaign can target a list of user segments that may be responsive to its offers. These targeting segments may influence the bid value. For instance, a car company may be willing to pay more for impressions to users who are interested in vehicles. Typically the value and thus price for inventory with highly desirable segments is significantly higher than the inventory with common segments. But at the same time the value of segments may not be equal for all advertiser campaigns. Some high value segments for a set of campaigns may not be appreciated by another set of campaigns. A regression model may be used to fine-tune the winning bid prediction so that the forecasting accuracy is improved. In order to capture the segment behavior on a bid, for each segment its number of occurrence, average bid value and bid standard deviation (std) should be observed and recorded. The features are extracted from the data for each sample. Key segments may be defined depending on the average bid and bid std. For example, key segments may be those with an average bid>five times the bid std. These key segments may be strong signals in the data due to their low variance, and they are likely to be the advertisers' targeted segments. For an incoming impression opportunity, its user segments list may be scanned and high level features may be extracted using the daily updated history data. In one embodiment, the features extracted may include: (1) Average bid value for all segments in the user segments list; (2) Maximum bid value for all segments in the user segments list; (3) Average bid value for key segments in the user segments list; and (4) Bid value of the key segment carrying the strongest signal (i.e., the largest mean/std ratio) in the user segments list. A linear regression “(LR”) model may be developed on these four segments features and the predicted bid value may be used to fine-tune the bid forecasting.

The bid forecasting may be utilized for short-term forecasting. However, longer term forecasting may be beneficial. A time series forecasting model family may be used model trends over time and seasonality at multiple granularities, and holiday factors for each publisher to perform long term bid forecast. The model family may include a yearly trend and seasonality model and Gaussian Process models with different configurations of mean function and covariance function.

From the observation that the sample winning bid values fit log normal distribution, the model of the campaign level won impression-bid distribution may be a mixture of log-normals, with each component be a log-normal distribution of sample-level predicted bid mean and std.

The response prediction model 306 provides click-through-rate (“CTR”) and conversion-rate (“CVR”) prediction for a supply sample and creative pair. The performance of the click and conversion forecasting in NGD forecasting system may depend on accurately predicting CTR and CVR. In the predict 306 sub-system, a tree based model may developed to arrange data into homogeneous hierarchy and then smooth the rate of clicks and conversion over the hierarchy using Gamma-Poisson mixture model. There may three separate trees for CTR, post view conversion (“PVC”), and post click conversion (“PCC”) prediction, respectively. Both categorical and numeric features extracted from the page, user, and/or ad creative may be used in the trees, with a Minimum-Description-Length (MDL) based supervised discretization for numeric attributes. For conversion forecasting, depending on the type of conversion id, which can be PVC or PCC, the conversion rate may be either PVC or CTR times PCC to estimate the probability of a conversion from a page view. By the predict model 306, the CTR and CVR may be predicted for using with final forecasting.

The final forecasting system 308 may integrate the estimated available impression, win rate, and predicted CTR/CVR to simulate the bidding logics of various pricing types and goal types to produce the final forecasting numbers for each sample. Final forecasting may be for generating the final numbers of won impressions, clicks and conversions. The final forecasting of clicks and conversions are calculated as based on the CTR and CVR. For example, clicks equals the won impressions times the CTR, while the conversions equals the won impressions times the CVR. The simulation of bidding logics may be for different types of campaigns.

For each impression, the cost may be defined as a charged amount for the creative and is related to the pricing type of each campaign. The value of each impression may be the return the creative expects to get from it and it may be associated with campaign's goal type. There may be four campaign pricing types: CPA, CPC, CPM, dCPM (dynamic CPM) that define how the advertisers are charged. There may be three goal types: None, CPA, CPC, and they may define how the advertisers measure their return from the campaign. Based on the pricing and goal types, there may be twelve combinations and for each one of them the bidding may use different logics to decide whether to participate in the auction and how much to bid for each impression. For pricing type campaigns with goals, the creative with highest cost (eCPM) and non-negative ROI (the value minus the cost) in a campaign participates in the auction for an impression. For campaigns without goals, the creative always participate in the auction with the calculated cost. A typical campaign may have one or more goals of type CPC or CPA, where each goal has a goal amount to measure the advertiser's expectation. The value of an impression for a creative may be calculated by summing up the contribution from all goals:

$$value = {\sum }_{i = 1}^{n} {λ}_{i}^{a} {g}_{i}$$

where λ^{a}ᵢ is the response prediction of an action (click or conversion depending on the goal type) for a creative for CPC goal or conversion i for CPA goal, and gᵢ is the goal amount of creative/conversion i. The cost of an impression for a may be decided by its pricing type and bid amount: cost=bid_amount×λ^{a} where λ^{a} is the probability of user action (for CPM and dCPM campaigns, λ^{view}=1). All the creatives bid on eCPM basis and although a line item may have multiple creatives, the creative with the highest eCPM would win the auction.

After a campaign decides to participate in an auction and the normalized bid (eCPM) is determined, and the portion of impressions for a given sample a it can win (defined as 0<=winrate<=1) is calculated by a cumulative density function (CDF) of the campaign's won impression-bid distribution generated in BLS 304. Accordingly, the probabilities of clicks and/or conversions may be applied to the won impressions to get the forecasted clicks and conversions. There may be multiple conversion ids for a selected creative (thus multiple PVC or PCC goal probabilities), in which case the average of all the goal probabilities associated with this creative may be used calculate conversions. For a campaign in query, the forecasted won impressions, clicks, and conversions for the samples may be aggregated to generate the results for the campaign. The last stage may aggregate the forecasting results for each sample and return a break-down report to the user. The system may be run in an ad-hoc mode to forecast for a given list of campaigns using a provided configuration.

As discussed above with respect to the aggregator 206 in FIG. 2, in the final forecasting sub-system, the forecasting results may be calibrated 310 by leveraging a campaign's performance history through a hybrid approach to generate the final forecasting of won impressions, clicks and conversion values. In particular, the historical impressions, clicks and conversions for the campaigns to be forecasted may be used as calibration for final forecasting results. The history information may provide a snapshot of the system running, and may be leveraged in the forecasting although the history may be for different campaign parameters (targeting attributes, bid/goal amounts etc.). The time series forecasting may be based on the campaign's performance history (if available) which is used as a baseline, and the end to end simulation based forecasting results may be adapted to generate the performance changes (measured by ratio) caused by the changes in campaign parameters in the query against the campaign parameters employed in the campaign history to adjust the baseline. Specifically, for each campaign historical campaign parameters as well as its won impressions, clicks, and conversions may be recorded. Based on the campaign history future performance may be forecasted using time series forecasting methods assuming the campaign parameters are not changed.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A method for forecasting an advertisement campaign comprising:
receiving information about the advertisement campaign;
estimating impressions based on the received information;
generating a winning bid distribution based on the estimated impressions;
modeling a click through rate (“CTR”) or a conversion rate (“CVR”) based on the winning bid distribution; and
forecasting won impressions, clicks, or conversions based on the modeling.

2. The method of claim 1 wherein the information about the advertisement campaign includes targeting information, such as a targeting profile or targeting attributes.

3. The method of claim 2 wherein the generating the winning bid distribution comprises identifying user segments based on the targeting information.

4. The method of claim 1 further comprising:
receiving a plurality of samples with the information about the advertisement campaign.

5. The method of claim 4 further comprising:
aggregating the forecasting based on a plurality of samples.

6. The method of claim 4 wherein the winning bid distribution is based on the plurality of samples and comprises a supply forecast.

7. The method of claim 1 wherein the modeling the CTR or CVR comprises utilizing a division tree based on a regression model.

8. The method of claim 1 wherein the forecasting won impressions, clicks, or conversions comprises an analysis with different bidding systems and pricing types.

9. The method of claim 8 wherein the forecasting includes a calibration with historical click data.

10. A system for advertisement forecasting comprising:
a supply forecaster that receives information about the advertisement and estimates impressions for the advertisement;
a bid landscape forecaster that utilizes the estimated impressions to generate a winning bid distribution;
a response prediction modeler that utilizes the winning bid distribution for estimating a click through rate (“CTR”) and a conversion rate (“CVR”); and
a final forecaster that utilizes the estimated CTR and CVR to estimate won impressions, clicks, and conversions.

11. The system of claim 10 further comprising:
an aggregator that utilizes click history data to calibrate the estimated won impressions, clicks, and conversions.

12. The system of claim 11 wherein the click history data is from a similar advertisement.

13. The system of claim 12 wherein the similar advertisement includes similar targeting attributes and features with the advertisement.

14. The system of claim 10 wherein the supply forecaster receives a request for a campaign that includes the advertisement.

15. The system of claim 14 wherein the information about the advertisement comprises campaign properties and includes targeting profile, targeting attributes, campaign pricing, goal types, goal bids, or goal amounts.

16. The system of claim 14 wherein the campaign comprises a plurality of samples for the advertisement.

17. The system of claim 16 wherein the estimated won impressions, clicks, and conversions is for each sample.

18. The system of claim 17 wherein final forecaster aggregates results from each of the samples.

19. A non-transitory computer readable medium having stored therein data representing instructions executable by a programmed processor for click prediction, the storage medium comprising instructions operative for:
receiving information about an advertisement campaign including a plurality of samples for the click prediction;
estimating impressions for the samples based on the received information;
determining a winning bid distribution based on the estimated impressions;
modeling the click prediction based on the winning bid distribution; and
forecasting results of the advertisement campaign based on the click prediction, wherein the results comprise an estimate for impressions, clicks, or conversions; and
aggregating the results over the plurality of samples.

20. The computer readable medium of claim 19 wherein the click prediction comprises click through rate (“CTR”) or a conversion rate (“CVR”).
